(19) United States
(12) Patent Application Publication
(10) Pub. No.: US 2007/0146988 A1
(43) Pub. Date: Jun. 28, 2007

(54) Electronic apparatus

(75) Inventors: Takuma Yamagishi, Tokyo (JP); Hironori Motoe, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/583,343

(22) Filed: Oct. 18, 2006

(30) Foreign Application Priority Data
Dec. 22, 2005 (JP) P2005-369769

(51) Int. Cl. G06F 1/20

(52) U.S. Cl. 361/687; 361/695; 165/80.3

(57) ABSTRACT

According to one embodiment, there is provided an electronic apparatus including: a casing including an upper surface; a keyboard mount section provided in the upper surface of the casing; and a fan case that is provided in the casing and has an air inlet port, the air inlet port being upwardly-opened. The keyboard mount section has a drain hole opposite to the air inlet port.

### CROSS-REFERENCE TO RELATED APPLICATIONS

This application is based upon and claims the benefit of priority from Japanese Patent Application No. 2005-369769, filed Dec. 22, 2005, the entire contents of which are incorporated herein by reference.

### BACKGROUND

1. Field

The present invention relates to an electronic apparatus having a keyboard mounted on an upper surface of a casing, and more particularly, to electronic apparatus taking into account of performance of drainage of the casing when a liquid such as water is spilled over the keyboard.

2. Description of the Related Art

In electronic apparatus such as a notebook-type personal computer, a keyboard mount section is formed on the upper surface of the casing forming a main body of the electronic apparatus, and a keyboard is provided on the keyboard mount section. A circuit board is placed in the casing, and a cooling device for cooling heat-generating members such as an IC board on which a circuit board is mounted; namely, a cooling device including a heatsink, a cooling fan, and the like, is incorporated in the casing.

When a liquid such as coffee or a beverage has been accidentally spilled over a keyboard during operation of the keyboard, there is a risk of intrusion of the liquid into the casing through a clearance between the keyboard and the keyboard mount section, and openings for wiring of the keyboard, or the like. Particularly, when the liquid has adhered to the circuit board, or the like, in the casing, there is a fear of being broken various types of circuit components mounted on the circuit board by a short circuit and the like. Accordingly, a drain structure for a keyboard, such as those described in connection with, Japanese Patent Application Publication (KOKAI) No. 2003-122454, Japanese Patent Application Publication (KOKAI) No. 7-234749, Japanese Utility Model No. 3023496, and U.S. Pat. No. 6,610,944 has been proposed.

Japanese Patent Application Publication (KOKAI) No. 2003-122454 discloses a drain structure of the keyboard having a first drain hole formed in a board of a keyboard, and a guide channel having a second drain hole provided below the first drain hole. A third drain hole opened to the outside of the casing is provided beneath the second drain hole. The first, second, a guide channel, and third drain holes, and the like, are formed in the board of the keyboard, the keyboard mount section, and the like.

Japanese Patent Application Publication (KOKAI) No. 7-234749, Japanese Utility Model No. 3023496, and U.S. Pat. No. 6,610,944 disclose drain structures of keyboards formed by resin molding in the board of the keyboard and the keyboard mount section and into custom-designed shapes used for draining the liquid spilled over the keyboard to below of the keyboard or to the outside of the casing.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a notebook-type personal computer showing an example of an electronic apparatus to which an embodiment of the present invention is applied;

FIG. 2 is an exemplary exploded perspective view of a main body casing;

FIG. 3 is an exemplary longitudinal cross-sectional view of a fan unit, a heatsink, a shroud, a main body casing, and a keyboard taken along line III-III shown in FIG. 2, showing a first embodiment of the present invention;

FIG. 4 is an enlarged view of IV section shown in FIG. 3;

FIG. 5 is an exemplary cross-sectional view showing flow of a liquid guided to an inside of a fan case;

FIG. 6 is an exemplary longitudinal cross-sectional view showing a second embodiment of the present invention;

FIG. 7 is an exemplary longitudinal cross-sectional view showing a third embodiment of the present invention;

FIG. 8 is an exemplary longitudinal cross-sectional view showing a fourth embodiment of the present invention; and

FIG. 9 is an enlarged view of section IX shown in FIG. 8.

### DETAILED DESCRIPTION

Various embodiments according to the invention will be described hereinafter with reference to the accompanying drawings. In general, according to one embodiment of the invention, there is provided an electronic apparatus including: a casing including an upper surface; a keyboard mount section provided in the upper surface of the casing; and a fan case that is provided in the casing and has an air inlet port, the air inlet port being upwardly-opened. The keyboard mount section has a drain hole opposite to the air inlet port.

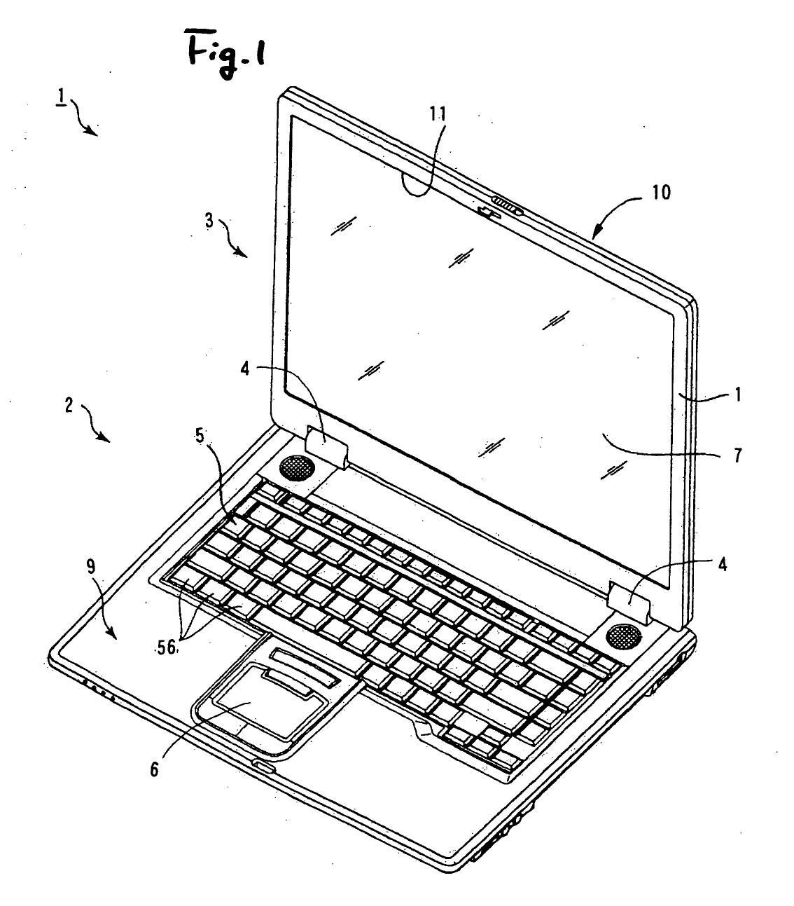

FIG. 1 is an exemplary perspective view of a notebook-type personal computer showing an example of an electronic apparatus to which an embodiment of the present invention is applied. In a personal computer 1, a display section 3 is connected to a main body 2 via a hinge section 4 so as to be able to open and close. A keyboard 5, a touch panel 6, and the like, are provided on an upper surface of the main body 2, and a liquid-crystal display panel (LCD) 7 is provided in the display section 3.

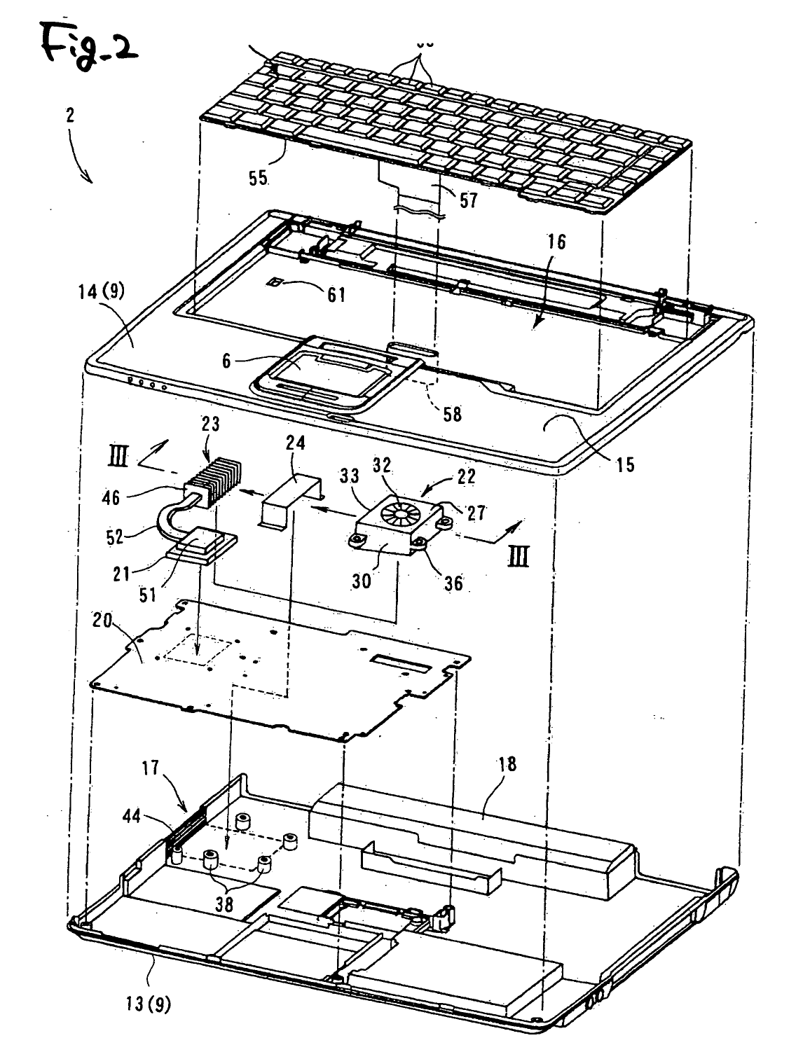

The main body 2 has a main body casing 9 made of resin, and the display section 3 has a display casing 10 made of resin. The display casing 10 has an exposure opening section 11 used for exposing the liquid-crystal display panel 7 incorporated in the display casing 10. FIG. 2 is an exemplary exploded perspective view of the main body casing 9.

The main body casing 9 has a casing base 13 at a lower side and a casing cover 14 at a upper side and is formed into a shape of a box. A keyboard mount section 16 is provided in a form of a tray in a recessed manner within an upper surface 15 of the casing cover 14. The keyboard 5 is removably placed on the keyboard mount section 16 by fitting in, screws, and the like. An air outlet port 17 is provided in, for example, a left surface of the main body casing 9 (the casing base 13).

A circuit board 20 is housed in the main body casing 9. A plurality of electrical components, such as an IC board 21, are mounted on an upper surface of the circuit board 20. A fan unit 22, a heatsink 23, and a shroud 24 are placed at a back of the circuit board 20 and at a left side of an interior of the main body casing 9.

### First Embodiment

FIG. 3 is an exemplary view showing a first embodiment of the present invention by a longitudinal cross-sectional view of the fan unit 22, the heatsink 23, the shroud 24, the main body casing 9 (the casing base 13 and the casing cover 14), and the keyboard 5, which is taken along line III-III shown in FIG. 2. At four corners of a lower surface of the casing base 13, rubber feet 25 for vibration absorbing and antislip are provided.

The fan unit 22 is provided with, for example, a fan case 27 made of resin or a metal plate. The fan case 27 is formed into a shape of a box having an upper surface 28, a bottom surface 29, a pair of front and back surfaces 30 (see FIG. 2), and a right surface 31. A circular air inlet port 32 is formed in the upper surface 28 so as to open upward, and an exhaust port 33 is formed in a left surface. The exhaust port 33 is opposite to the air outlet port 17 of the main body casing 9.

A total of four fastening pieces 36 provided on the front and back surfaces 30 and the right surface an inner end face 31 of the fan unit are fastened to fastening bosses 38 formed integrally on the bottom surface of the casing base 13 by screws 37, to thus fix the fan unit 22 (the fan case 27) to the interior of the main body casing 9. The bottom surface 29 of the fan case 27 is slightly sloped downwardly toward the exhaust port 33.

A fan 41 is provided beneath the air inlet port 32 of the fan case 27, so as to be opposite to the air inlet port 32. The fan 41 is rotationally driven by a fan motor 42 placed at the center of the air inlet port 32. The fan 41 and the fan motor 42 are upwardly spaced apart from the bottom surface 29 of the fan case 27.

The heatsink 23 is provided between the fan 41 (the exhaust port 33) of the fan unit 22 and the air outlet port 17 of the main body casing 9. The heatsink 23 is placed immediately behind the air outlet port 17 when viewed from the outside. The shroud 24 covers the front and back surfaces and the upper surface of the heatsink 23 to form an air-guide passage extending from the exhaust port 33 to the air outlet port 17 of the fan case 27. The air outlet port 17 is provided with a louver 44 (air-guide) which has a shape of a lining board. This louver 44 is for downwardly guiding the flow of air discharged outside from the air outlet port 17.

The heatsink 23 is formed by placing, at minute intervals and in parallel with each other, a plurality of flat-plate-like heat radiating fins 46 made from an aluminum plate, a copper plate, or the like. Since the IC board 21 is a heat-generating component, a heat-receiving member 51, which is formed into a rectangular shape from a good heat-conducting material such as aluminum or copper is placed on the IC board 21. A lower surface of the heat-receiving member 51 and an upper surface of the IC board 21 planarly contact with each other to thermally connect together. A heat pipe 52 extending from the heat-receiving member 51 penetrates through and is thermally connected to the heat-radiating fins 46 of the heatsink 23. The heat pipe 52 has a known structure where a metal pipe with both ends thereof closed, such as an aluminum pipe or a brass pipe, is sealed with a coolant such as water and Freon with air therein.

The heat generated during operation of the IC board 21 is received by the heat-receiving member 51, and is transferred further to the heatsink 23 by the heat pipe 52. When the fan motor 42 of the fan unit 22 is started to rotate the fan 41, the internal air of the main body casing 9 is suctioned into the fan case 27 through the air inlet port 32. The suctioned air passes through the space among the plurality of heat-radiating fins 46 of the heatsink 23 disposed in the shroud 24, and is discharged outside from the exhaust port 33 of the main body casing 9. At that time, the heat of the IC board 21 transferred to the heatsink 23 is exchanged and discharged from the exhaust port 33. Then, the IC board 21 is cooled.

As shown in FIG. 3, in the keyboard 5, a plurality of key buttons 56 are provided in an upper surface of a keyboard substrate 55. A band-shaped cable wiring 57 (see FIG. 2) extending from the keyboard 55 is inserted into the main body casing 9 through a wiring duct 58 formed in the keyboard mount section 16, and is connected to an unillustrated coupler provided on a circuit board 20. The cable wiring 57 transmits a signal input to the keyboard substrate 55 to the circuit 20 by pressing a key button 56.

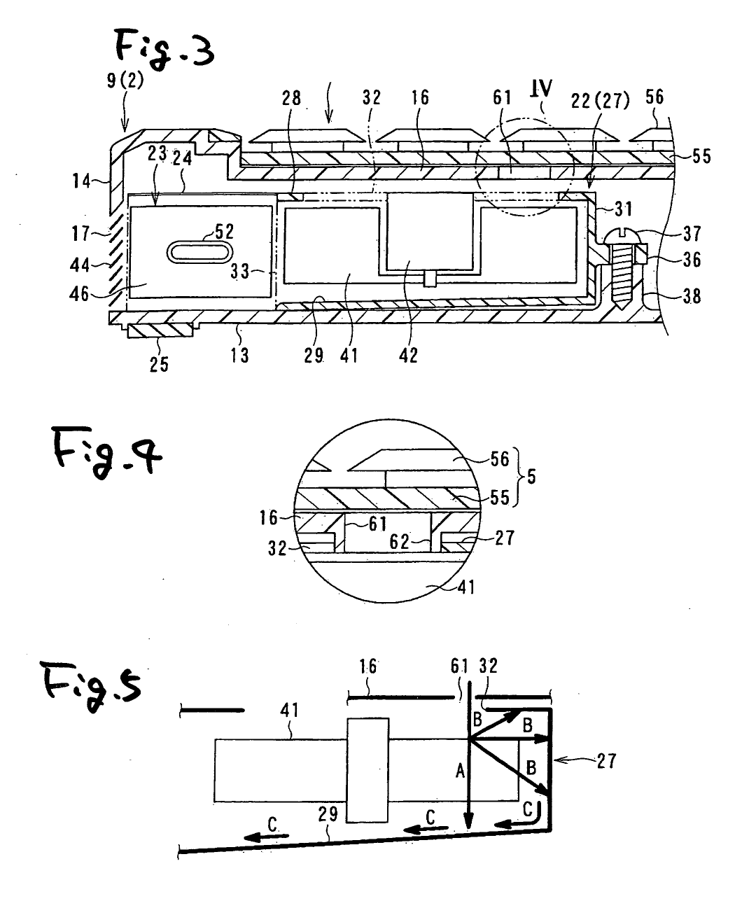

The keyboard mounting section 16 is formed with a drain hole 61. This drain hole 61 is located directly above the air inlet port 32 of the fan case 27 and opposite to the air inlet port 32. More specifically, the drain hole 61 is located so as to avoid a location directly above the fan motor 42, and is located at a position above vanes of the fan 41. The drain hole 61 shown in FIG. 3 has a shape of a mere open hole, but a downwardly-extending duct-shaped elongated portion 62 may also be formed monolithically with the drain hole 61 as shown in FIG. 4. The shape of the drain hole 61 is not particularly limited and the drain hole may also have, e.g., an angular shape, a round shape, or the shape of a slit.

In the personal computer 1 formed as mentioned above, when a liquid such as coffee or a beverage has been accidentally spilled over the keyboard 5, the liquid is guided to the inside of the fan case 27 from the air inlet port 32 of the fan case 27 by a clearance between the keyboard 5 and the keyboard mount section 16 and through a drain hole 61.

As schematically shown in FIG. 5, the liquid guided to the inside of the fan case 27 from the drain hole 61 and the air inlet port 32 drops beneath as indicated by arrow A when the fan 41 is inoperative. When the fan 41 rotates, the liquid collides against the fan 41 to thus splash in a centrifugal direction as indicated by arrow B. In either case A or B, the liquid falls on the bottom surface 29 of the fan case 27. Since the bottom surface 29 is slightly sloped downwardly toward the exhaust port 33, the liquid having fallen on the bottom surface 29 flows toward the exhaust port 33 as indicated by arrow C. Finally, the liquid is discharged outside from the air outlet port 17. The bottom surface 29 of the fan case 27 may be extended to the air outlet port 17.

Whole of the liquid that has splashed in the fan case 27 upon contact with the rotating fan 41 is discharged outside from the outlet port 17, without splashing back upwardly from the air intake port 32, through the exhaust port 33 while passing through the fan case 27, by an downward air current flowing from the air intake port 32 to the inside of the fan case 27, the strong centrifugal force stemming from rotation of the fan 41, and a relationship of the air inlet port 32 being smaller than the outer diameter of the fan 41.

A part of the liquid having collided with the rotating fan 41 is sprayed outside from the air outlet port 17 in the form of fine droplets or a mist. The discharged droplets or mist is guided downwardly by the louver 44 provided in the air outlet port 17. Hence, even when, for example, papers or the like are placed adjacently on the left of the personal computer 1, the liquid hardly falls on the papers or the like. Thus, the papers can be prevented from getting wet.

Moreover, the liquid having become such fine droplets or the mist is discharged from the air outlet port 17 after having passed among the heat-radiating fins 46 of the heatsink 23 that is a high temperature. When the liquid passes through the heatsink 23, a portion of the liquid is vaporized, thereby preventing emission of a large quantity of liquid from the air outlet port 17. The heatsink 23 itself acts as a shield against the liquid, and hence the speed of the liquid emitted from the air outlet port 17 can be remarkably decreased.

Accordingly, in the embodiment of the invention, the fan case 27 that has hitherto been provided in the main body casing 9 is also utilized as a drain passage for the liquid spilled over the keyboard 5. Thereby, the liquid having spilled over the keyboard 5 can be quickly discharged outside without involvement of contact with the circuit board 20 in the main body casing 9 or the electronic components such as the IC board 21 by a very simple structure and without making the structure of each of constituent members including the main body casing 9 complicated. Thus, the durability of the personal computer 1 can be enhanced.

### Second Embodiment

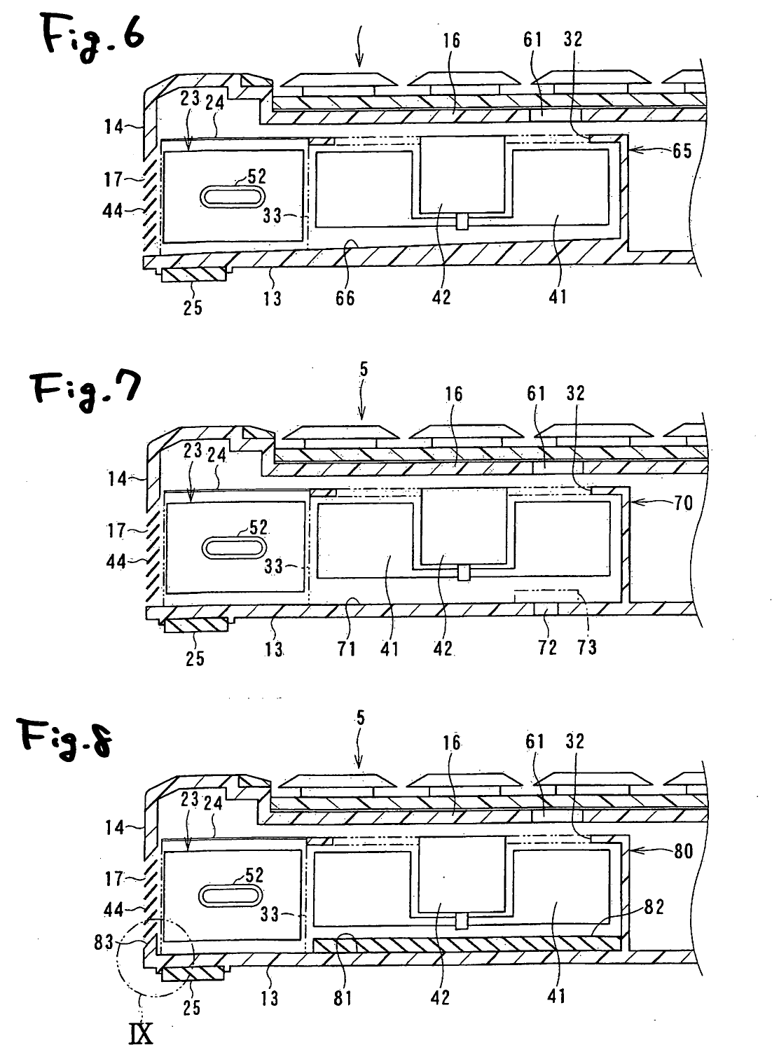

FIG. 6 shows a second embodiment of the present invention. A fan case 65 made of resin is formed monolithically with the bottom of the casing base 13 that is also made of the resin. The bottom surface 66 in the fan case 65 is slightly sloped downwardly toward the discharge port 33 (the air outlet port 17) as in the case of the first embodiment. In other respects, the second embodiment is identical with the first embodiment in terms of configuration and operation. Therefore, all the identical portions are assigned the same reference numerals, and their explanations are omitted.

Since the fan case 65 is formed monolithically with the bottom of the casing base 13, the number of components and assembly processes is curtailed, which in turn contributes to cost-cutting and weight reduction of the main body casing 9. Further, an attempt can be made to eliminate wasteful clearance between the casing base 13 and the fan case 65 to make the main body casing 9 slim. The shroud 24 may be monolithically provided with the casing base 13, the casing cover 14, the fan case 65, and the like.

### Third Embodiment

FIG. 7 shows a third embodiment of the present invention. Although a fan case 70 is monolithically formed with the bottom surface of the casing base 13 made of resin, the fan case 70 may be provided separately. Moreover, although a bottom surface 71 in the fan case 70 is even, the bottom surface may be slightly sloped downwardly toward the discharge port 33 (the air outlet port 17).

The bottom surface 71 of the fan case 70 is formed with a second drain hole 72 beneath the drain hole 61 of the keyboard mount section 16. The size of the second drain hole 72 is made small to such an extent that the amount of blast to the discharge port 33 created by the fan 41 does not reduce. Specifically, the reason for this is that, as the size of the second drain hole 72 becomes greater, the air suctioned into the fan case 70 from the air intake port 32 by the fan 41 leaks out of the second drain hole 72, so that a sufficient quantity of cooling air cannot be blown toward the heatsink 23. A size of the second drain hole 72 can be such that water droplets can pass through the second drain hole 72. A water-absorbing member 73, such as a sponge, may be laid over the second drain hole 72. When the fan case 70 is formed as different member from the casing base 13, the second drain hole 72 is formed both in the bottom surface 71 of the fan case 70 and the bottom surface of the casing base 13.

When the liquid has spilled over the keyboard 5, the liquid passes through the clearance between the keyboard 5 and the keyboard mount section 16 and through the drain hole 61, to thus be guided to the inside of the fan case 70 from the air intake port 32 of the fan case 70. When the fan 41 is at a standstill, the liquid flows outside from the second drain hole 72 beneath the drain hole 61. When the fan 41 is rotating, the liquid collides against the fan 41 to thus be splashed within the fan case 70. The thus-splashed liquid immediately drops on the bottom surface 71 and flows outside the second drain hole 72 or the discharge port 73 (the air outlet port 17). Alternatively, as in the case of the first embodiment, the liquid is atomized and discharged outside of the air outlet port 17. In addition, outer air is suctioned into the fan case 27 through the second drain hole 72.

As a result of forming the second drain hole 72, the liquid having flowed into the fan case 70 can be immediately discharged outside. Further, as a result of the water-absorbing member 73 being laid on the second drain hole 72, the liquid is discharged out from the second drain hole 72 without decreasing the amount of blast to the discharge port 33, as well. Further, intrusion of dust or the like from the outside into the fan case 70 can be hindered. The bottom surface 71 of the fan case 70 is formed into a shape of a shallow mortar so as to taper down toward, e.g., the second drain hole 72, whereby the liquid having flowed down into the fan case 70 can be quickly discharged more actively from the second drain hole 72.

### Fourth Embodiment

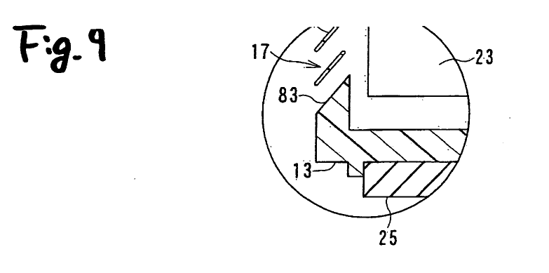

FIG. 8 shows a fourth embodiment of the present invention. A fan case 80 is provided monolithically or separately on the bottom surface of the casing base 13 made of resin. The fan case 80 includes a bottom surface 81 that is even. A hole, such as a drain port or the like, is not formed in this bottom surface 81. In stead of the hole, a water-absorbing member 82, such as a sponge, is laid over a comparatively-wide area. As illustrated in FIG. 9 in an enlarged manner, for instance, a liquid block portion 83 standing in an edge-shaped manner is provided along the lower edge of the air outlet port 17.

The liquid that has spilled over the keyboard 5 is guided to the inside of the fan case 80 from the air inlet port 32 of the fan case 80 through the drain hole 61, and flows downwardly to the bottom surface 81 of the fan case 80 and is absorbed by the water-absorbing member 82. When the quantity of the liquid is small, the liquid absorbed by the water-absorbing member 82 is naturally dried by the drafting function of the fan 41.

When the quantity of the liquid is large, the liquid flows toward the air outlet port 17 over the bottom surface 81. However, the liquid is blocked by the liquid block portion 83 provided along a lower edge of the air outlet port 17, and hence a time lag arises before the liquid flows to the outside. Consequently, it is possible to gain time to put documents or the like, which are placed beside the personal computer 1, out of the way of the liquid, thereby preventing the documents or the like from getting wet. When the liquid has splashed upon contact with the rotating fan 41, operation to be performed is the same as that in the first embodiment.

The notebook-type personal computer has been described in the embodiments. However, the present invention is not limited to the notebook-type personal computer and can be widely applied, so long as the electronic apparatus has a keyboard and a fan case provided below a keyboard.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An electronic apparatus comprising:
a casing including an upper surface;
a keyboard mount section provided on the upper surface of the casing; and
a fan case that is provided in the casing and has an air inlet port, the air inlet port being upwardly-opened,
wherein the keyboard mount section has a drain hole opposite to the air inlet port.

2. The electronic apparatus according to claim 1,
wherein the casing includes a side surface having an air outlet port, and
wherein the fan case has an exhaust port opposite to the air outlet port.

3. The electronic apparatus according to claim 2, further comprising a heatsink,
wherein the fan case includes a fan provided opposite to the air inlet port, and
wherein the heatsink is provided between the fan and the air outlet port.

4. The electronic apparatus according to claim 3, wherein the fan case includes a bottom surface sloped downwardly toward the exhaust port.

5. The electronic apparatus according to claim 3, wherein the air outlet port includes an air-guide that downwardly guides a flow of an exhausted air from the fun case.

6. The electronic apparatus according to claim 3, wherein the fun case includes a bottom surface having a water-absorbing member thereon.

7. The electronic apparatus according to claim 3, further comprising a liquid block portion provided along a lower edge of the air outlet port, the liquid block portion standing from a bottom surface of the casing.

8. The electronic apparatus according to claim 3, wherein a bottom surface of the fun case and a bottom surface of the casing is formed with a second drain hole beneath the drain hole.

9. The electronic apparatus according to claim 8, wherein the outer air is suctioned into the fun case through the second drain hole.

10. The electronic apparatus according to claim 3, wherein the fun case includes a bottom surface monolithically formed with the casing.
